(19) United States
(12) Patent Application Publication
(10) Pub. No.: US 2025/0095378 A1
(43) Pub. Date: Mar. 20, 2025

(54) VEHICLE RECOGNITION SYSTEMS AND METHODS

(71) Applicant: NxtWash, LLC, Lewes, DE (US)

(72) Inventors: Justin Ruelas, Denver, CO (US); David Selsberg, Lewes, DE (US); Dorjan Hajdari, Milford, MA (US)

(73) Assignee: NxtWash, LLC, Lewes, DE (US)

(21) Appl. No.: 18/885,678

(22) Filed: Sep. 15, 2024

Related U.S. Application Data
(63) Continuation of application No. 63/583,229, filed on Sep. 15, 2023.

(51) Int. Cl. G06V 20/54; G01J 5/00; G06V 10/82; G06V 20/62; G06V 30/10; G08G 1/017

(52) U.S. Cl. CPC G06V 20/54; G01J 5/00; G06V 10/82; G06V 20/625; G06V 30/10; G08G 1/0175; G01J 2005/0077; G06V 2201/08

(57) ABSTRACT

Methods and systems are described, including receiving, at a server from a computing device associated with at least one camera, at least one image of a vehicle detected in a vehicle detection zone during a first time period, generating, using the at least one image, a prediction of at least one data object associated with the vehicle, determining whether the prediction of the at least one data object matches a vehicle profile, and communicating a result of determining whether the prediction of the prediction matches the vehicle profile. The methods and systems may include creating, based on determining that the prediction of the at least one data object fails to match the vehicle profile, a new vehicle profile for the vehicle including at least one descriptor corresponding to the at least one data object and assigning a vehicle token to the vehicle profile.

### RELATED APPLICATIONS

This application claims the benefit of U.S. Provisional Patent Application Ser. No. 63/583,229 filed on Sep. 15, 2023, the contents of which are incorporated by reference in their entirety.

### FIELD OF TECHNOLOGY

The present disclosure relates generally to computing systems and data processing, and more specifically to vehicle recognition systems and methods.

### BACKGROUND

Some vehicle identification software solutions leverage a computer vision model to check an image for a license plate. If a license plate is detected, a second computer vision application extracts relevant alphanumerics with optical character recognition, and returns values detected to identify the vehicle. While these methods and systems focus on license plate alphanumerics, the data is largely informational, subject to incorrect readings, and may not account for camera deficiencies to capture the entirety of the alphanumerics due for example to vehicles in motion, lack of accessible angles, missing license plates, and weather.

### SUMMARY

In one general aspect, the method may include receiving, at a server and from a computing device associated with a camera, at least one image of a vehicle detected in a vehicle detection zone during a first time period. The method may also include generating, using the at least one image, a prediction of at least one data object associated with the vehicle. The method may furthermore include determining whether the prediction of the at least one data object matches a vehicle profile from a vehicle profile data store. The method may in addition include communicating a result of determining whether the prediction of the at least one data object matches the vehicle profile.

Other embodiments of this aspect include corresponding computer systems, apparatus, and computer programs recorded on one or more computer storage devices, each configured to perform the actions of the methods.

Implementations may include one or more of the following features. The method may comprise creating, based at least in part on determining that the prediction of the at least one data object fails to match the vehicle profile, a new vehicle profile for the vehicle having at least one descriptor corresponding to the at least one data object and assigning a vehicle token to the vehicle profile, where communicating the result may include storing the vehicle profile in a data store. The method may further comprise generating the prediction of the at least one data object by transmitting, to one or more vehicle identification services, the at least one image of the vehicle and generating, by the one or more vehicle identification services, a predicted license plate string identified from the at least one image, where the prediction may include the predicted license plate string and a confidence score associated with the prediction of the predicted license plate string. The method may also include determining whether the prediction of the at least one data object matches the vehicle profile by determining, based at least in part on the confidence score being greater than a threshold, whether the predicted license plate string matches a license plate string in a plurality of vehicle profiles in the vehicle profile data store. The method may further comprise determining whether the prediction of the at least one data object matches the vehicle profile by determining, that the confidence score is less than a threshold, identifying a subset of vehicle profiles of a plurality of vehicle profiles in the vehicle profile data store that have a license plate string length that matches a license plate string length of the predicted license plate string, and determining whether a threshold quantity of characters are matched between the predicted license plate string and respective license plate strings of the subset of vehicle profiles.

Implementations may further include one or more of the following features. The method may also comprise determining, based at least in part on a threshold quantity of characters being matched, whether at least one additional data object prediction from the at least one image of the vehicle and having a make, model, or color, matches corresponding data objects of the subset of vehicle profiles, where the at least one additional data object is received from the one or more vehicle identification services. The method where the threshold quantity is based on the license plate string length. The method where the one or more vehicle identification services are configured to return a prediction of at least one of a make of the vehicle and a model of the vehicle, using a vehicle identification procedure that may include identifying a feature of the vehicle, drawing reference points on each feature, measuring a respective distance between each pair of reference points, generating a point distance ratio from the respective distances between each pair of reference points, and generating the prediction of at least one of the make of the vehicle and the model of the vehicle, based at least in part on the point distance ratio. The method may also comprise communicating the result, which may include transmitting, to the computing device, at least one of an identifier for the matched vehicle profile and an identifier for a generated new vehicle profile. The method may further comprise generating the prediction, which may include detecting, based at least at in part, on one or more heat signatures included in the at least one image that may include a thermal image captured by the camera that may include a thermal camera, identifiable features of the vehicle, and generating the prediction based at least in part on the identifiable features of the vehicle. The method where the identifiable features may include the hood structure of a hood of the vehicle. The method of communicating the result which may comprise communicating to the computing device, an identifier for the vehicle, where the computing device is configured to perform one or more actions based at least in part on the identifier.

Implementations of the techniques described may include hardware, a method or process, or a computer tangible medium.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 illustrates an example of a data processing environment that supports vehicle recognition systems and methods in accordance with aspects of the present disclosure.

FIG. 2 shows an example of a process flow that supports vehicle recognition systems and methods in accordance with aspects of the present disclosure.

FIG. 3 shows an example of a flowchart that supports vehicle recognition systems and methods in accordance with aspects of the present disclosure.

FIG. 4 shows an example of a fingerprint detection technique that supports vehicle recognition systems and methods in accordance with aspects of the present disclosure.

FIG. 5 shows an example of a flowchart that supports vehicle recognition systems and methods in accordance with aspects of the present disclosure.

FIG. 6 shows a block diagram of an example apparatus that supports vehicle recognition systems and methods in accordance with aspects of the present disclosure.

FIG. 7 shows a block diagram of a matching manager that supports vehicle recognition systems and methods in accordance with aspects of the present disclosure.

FIG. 8 shows a diagram of a system including a device that supports vehicle recognition systems and methods in accordance with aspects of the present disclosure.

FIGS. 9 through 14 show flowcharts illustrating methods that support vehicle recognition systems and methods in accordance with aspects of the present disclosure.

### DETAILED DESCRIPTION

The disclosed technology includes vehicle recognition systems and methods including identifying data objects based on a captured image of a vehicle, determining whether the data objects match data objects of known vehicle profiles, and providing an identifier for a matched profile or generating a profile if a match is not identified. The techniques described herein leverage various vehicle identification techniques, such as image recognition techniques (e.g., for identifying make, model, plate characters) and heat signature analysis, in addition to profile matching techniques to identify and profile vehicles. The identification techniques may provide a more robust and accurate vehicle identification relative to other techniques. Further, because vehicle profiles may be created and matched upon subsequent vehicle identification, the profiles may be leveraged to support various actions, such as opening gates. For example, a computing system associated with a gated area may be provided with an allowed list of vehicles, when an allowed vehicle is identified using the techniques described herein, then the gate may be opened to allow the vehicle into the gated area. These and other techniques are described in further detail with respect to the figures.

Aspects of the disclosure are initially described in the context of an environment supporting an on-demand database service. Aspects of the disclosure are described with reference to a computing environment, a process flow diagram, flowcharts, and a vehicle identification technique. Aspects of the disclosure are further illustrated by and described with reference to apparatus diagrams, system diagrams, and flowcharts that relate to vehicle recognition systems and methods.

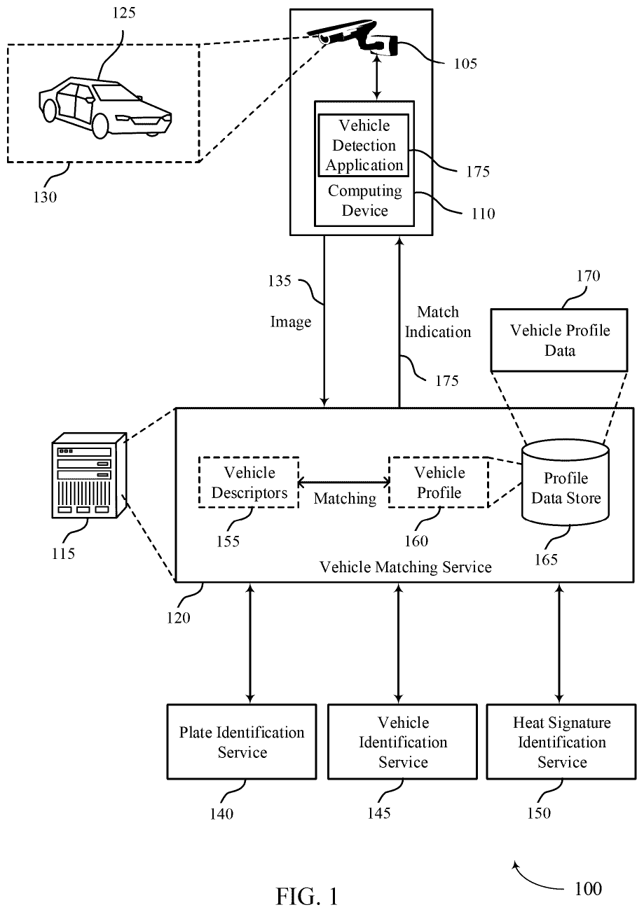

FIG. 1 illustrates an example of a computing system 100 for cloud computing that supports vehicle recognition systems and methods in accordance with various aspects of the present disclosure. The computing system 100 includes a server 115, a camera 105, a computing device 110, among other aspects.

The camera 105 may be an example of a video camera (e.g., an AXIS Camera) that provides a video stream for detecting vehicles by the computing device 110. In some embodiments, the camera 105 may capture various types of images (e.g., cooled infrared, uncooled infrared, night vision, thermal, active IR, and any other appropriate image capture format). The computing device 110 may be an example of a computer (e.g., NVIDIA Jetson) that executes an application (e.g., a vehicle detection application 175), such as, by way of example, an OpenCV application, that detects vehicles in a detection zone 125. The camera 105 and the computing device 110 may be co-located at the edge (e.g., at a location configured to detect vehicles that enter the vehicle detection zone 130). Alternatively, the camera 105 and the computing device 110 may be located in different geographic locations and may be networked to support the techniques described herein. At 135, the computing device 110 may provide an image of the detected vehicle to a vehicle matching service 120 supported by the server 115. For example, the computing device 110 may transmit an application programming interface (API) request to the vehicle matching service 120, and the request may include the image of the detected vehicle.

The vehicle matching service 120 may perform various operations to identify the vehicle, match the vehicle to a known vehicle profile, and/or create a profile of the vehicle. The vehicle matching service 120 may be an example of a service implemented by a webserver (e.g., a TIREPRINTS AWS web server). As such, the server 115 that supports the vehicle matching service 120 may be an example of or represent one or more webservers. The vehicle matching service 120 may leverage various vehicle identification services to provide data object identification associated with the vehicle. In some cases, the vehicle matching service 120 sends the image to one or more of a plate identification service 140, a vehicle identification service 145, and a heat signature identification service 150. These services may be separate services and/or may be part of the same vehicle identification service. For example, the vehicle matching service 120 may send the image to a web-based API (e.g., REKOR OpenALPR web-based API) that generates a prediction of at least one data object from the image (e.g., license plate, year, make, color, thermal pattern, and model of a vehicle). The web-based API then returns the prediction of at least one data object from the image to the vehicle matching service 120. The returned prediction may include a confidence score associated with the prediction of one or more of the predicted data objects.

The vehicle matching service 120 may maintain or access a profile data store 165 that stores vehicle profile data 170 for multiple vehicles. The profile data store 165 may be an example of or may be implemented in an MS SQL server hosted on a separate AWS EC2 instance. Each profile may include a set of descriptors corresponding to data objects identified for vehicles, such as license plate, year, make, color, and model of a vehicle. When a vehicle is identified using one or more of the services as described herein, the vehicle matching service 120 may determine whether the identified data objects (e.g., vehicle descriptors 155) match one or more profiles of the profile data store 165, such as vehicle profile 160. For example, the vehicle matching service 120 may implement a matching algorithm (described in further detail herein) to determine whether the identified data objects for a detected vehicle match one or more profiles of the profile data store 165. When a match is found, the vehicle matching service may return an identifier (e.g., token) corresponding to the profile to the computing device 110 at 175. Alternatively, when no match is found, the vehicle matching service 120 creates a profile with descriptors corresponding to the data objects and assigns a token to the profile. In some cases, the token is sent from the vehicle matching service 120 to a third-party system for storage in association with the descriptors and/or data objects. When the same vehicle returns at a second time period, even when the plate is read incorrectly or cannot be read in its entirety, the matching algorithm may match the vehicle correctly as long as some parts of the license plate, in combination with other data objects, are readable. The advantage of the disclosed technology is tokenizing vehicles using multiple points of data rather than focusing only on the license plate.

In some cases, the components of the system include the vehicle detection application 175 on the computing device 110, the NVIDIA Jetson Xavier NX computer and supporting hardware (e.g., the computing device 110), the TIREPRINTS AWS server (e.g., the vehicle matching service 120), a first or third-party license plate, year, make, model, color artificial intelligence (AI) model (e.g., in one or more of the plate identification service 140, the vehicle identification service 145, and the heat signature identification service 150), and the matching algorithm running on the TIREPRINTS web server (e.g., the vehicle matching service 120).

The vehicle detection application 175 is ideal for the angle, distance, and high volume of vehicle detections. However, other applications can be substituted in its place as long as the vehicle is detected in the correct position. The NVIDIA Jetson computer (e.g., the computing device 110) allows the vehicle detection application 175 to run on the local network of the user. The computing device 110 allows a connection to any standard network camera that offers an accessible video stream using standard technologies such as Real Time Streaming Protocol (RTSP). The vehicle matching service 120 facilitates the data storage, image storage, handoffs, and operation of the matching algorithm. In addition, the vehicle matching service 120 supports user roles and partitions out data locations based on end user account preferences. In some cases, the vehicle matching service 120 is supported by an AWS EC2 webserver instance that supports the API and may be implemented by .NET core technology.

In some examples, a third-party license plate, year, make, model, color AI model is provided to the TIREPRINTS server uses to create the tokens. The matching algorithm in the vehicle matching application permits misreads of license plates or make, models, and colors, interchangeably while still being able to identify the correct vehicle. This is extremely useful in access control use cases, such as parking garages, hospital staff parking and residential home garage, but can also be used to minimize human intervention in automated post detection event use cases.

The vehicle matching service 120 may support various administrator roles. For example, a “super admin” may create a company (e.g., a logical instance of the vehicle matching service 120) and also create a default location and admin user account for the company by going to http://www.tireprints.com/admin. The super admin may see the stats of the companies registered and may see the locations of the companies and can manage the locations of different companies. A company admin may access the company admin portal by going to http://www.tireprints.com. Company admin may access stats of vehicles scans on the dashboard and may see the vehicles records which were scanned and download the report of vehicle registered in the TIREPRINTS system. A vehicle Scans page may show every scan of the vehicles. The company admin may also manage the locations and users, configure the camera per location in the company, configure allow and deny lists for each location or for multiple locations, etc.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

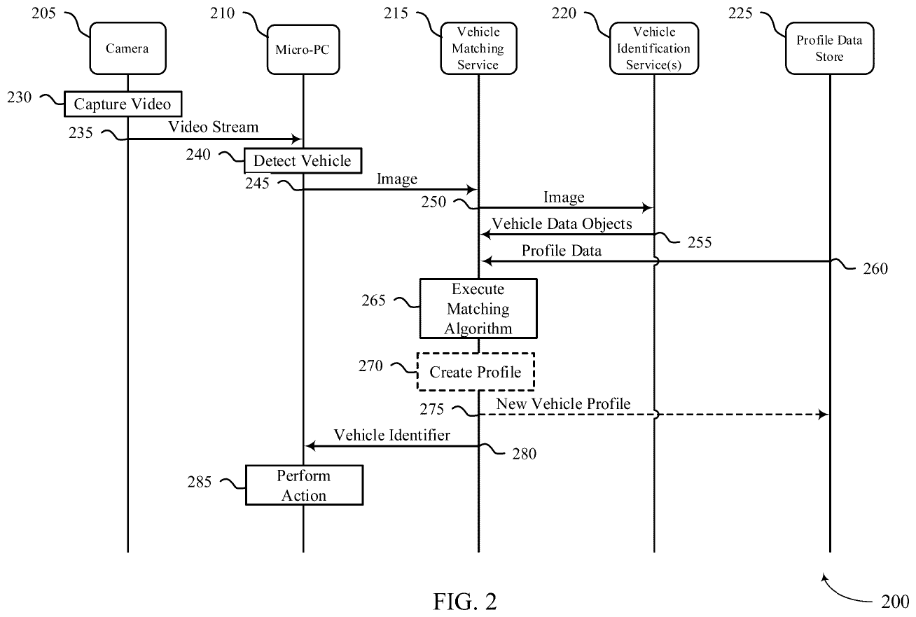

FIG. 2 shows an example of a process flow 200 that supports vehicle recognition systems and methods in accordance with aspects of the present disclosure. The process flow 200 includes a camera 205, a micro-PC 210, a vehicle matching service 215, one or more vehicle identification services 220, and a profile data store 225, which may be examples of the corresponding devices or systems as described with respect to FIG. 1. For example, the camera 205 may be an example of the camera 105, and the micro-PC 210 may be an example of the computing device 110 of FIG. 1.

At 230, the camera 205 may capture video of a detection zone, and at 235 the video stream of the detection zone may be provided to the micro-PC 210. At 240, the micro-PC may detect a vehicle in the detection zone based on the video stream. At 245, an image of the detected vehicle may be provided to the vehicle matching service 215 (e.g., a cloud server) via an API request, or the like. At 250, the vehicle matching service 215 may provide the image to one or more vehicle identification services. The vehicle identification services may perform one or more techniques to identify or predict data objects of the vehicle, such as make, model, color, license plate, and year. At 255, the one or more vehicle identification services 220 may provide (e.g., an API response) the identified vehicle data objects to the vehicle matching service 215.

At 260, the vehicle matching service 215 may obtain profile data for a plurality of vehicles from the profile data store 225. At 265, the vehicle matching service may execute a matching algorithm to determine whether the prediction of the at least one data object matches a vehicle profile from a vehicle profile data store 225. If the vehicle matching service determines that the predicted data objects do not match a vehicle profile of the profile data store 225, then, at 270, the vehicle matching service 215 may create a new vehicle profile for the vehicle, and the new vehicle profile may include at least one descriptor corresponding to the at least one data object. The vehicle matching service 215 may assign a vehicle token to the created vehicle profile. At 275, the vehicle matching service 215 may communicate the vehicle profile to the profile data store 225 for storage in association with the token. At 280, the vehicle matching service 215 may provide an identifier for the vehicle or vehicle profile (e.g., the token) to the micro-PC 210. At 285, the micro-PC 210 may perform one or more actions based on the identifier. For example, if the identified vehicle is on an allow list, then the micro-PC may open a gate or to allow the vehicle into a gated area.

When the vehicle matching service 215 creates the profile, then the vehicle may be detected during a second period (e.g., at a later time). The vehicle matching service 215 may perform similar techniques to generate the data objects and then match the generated data objects to the created profile (e.g., using the matching algorithm).

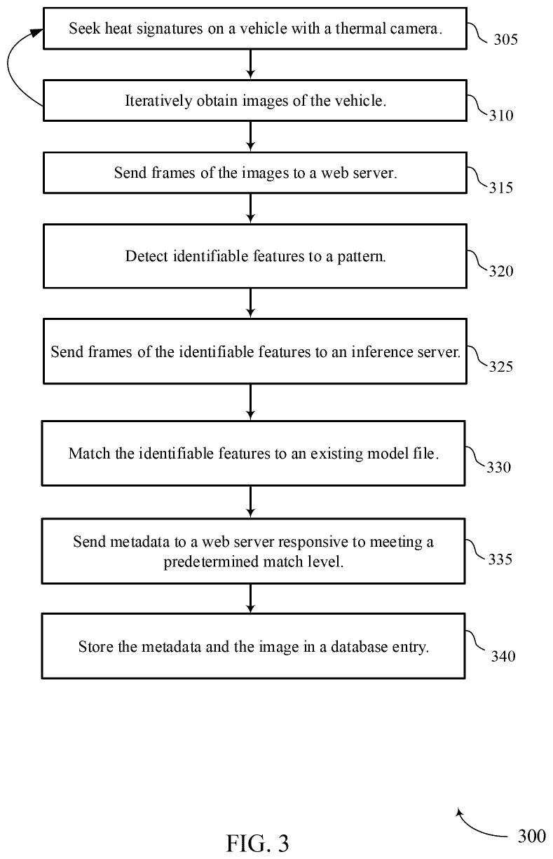

FIG. 3 shows an example of a flowchart 300 that supports the vehicle recognition systems and methods in accordance with aspects of the present disclosure. In some examples, a method may include identifying vehicles by using thermal cameras. A thermal camera (e.g., the camera 105 of FIG. 1 or the camera 205 of FIG. 2) may be directed toward a vehicle (e.g., the hood on the front of the vehicle). At 305, the thermal camera will seek heat signatures of the underlying metal structure and framing of the hood. At 310, a computer vision application will continuously view frames from the thermal camera. At 315, the frames are sent via a network video stream to a hardware processing point (e.g., a NVIDIA Jetson Xavier series device, such as the computing device 110 of FIG. 1). The device may be placed near or at the same relative location as the camera that is providing the video feed to yield more accurate results. In another example, the device may also be placed in a remote location. At 320, the computer vision application may detect at the hardware level whether identifiable features are located on the vehicle's hood in a frame. Once the identifiable features are detected, at 325, the computer vision application may send the frames to an inference server (e.g., to the heat signature identification service 150 via the vehicle matching service). At 330, the server may check each frame and match the identifiable features to an existing pattern or “model file” in a matching operation. The model file contains data of previous images with objects in the images identified (e.g., manually identified).

At 335, when there is a high match between the frame being analyzed and a manually defined object and the match meets a predetermined match level, the inference server will send the metadata (e.g., data objects) for that result, which includes the identified match (Make/Model), a confidence score in the match, and the coordinates of the bounding box surrounding the object to a webserver. For example, if there is an 80% confidence in the match to a hood of a Honda Civic and a 40% confidence match to a hood of a Toyota Corolla, based on the model file, the actual resulting match may be the one above a certain % level match and the highest match. In this example, the match would be the Honda Civic (e.g., as a make data object and a model data object), as 80% confidence match is a greater amount. Once the vehicle hood pattern is matched with an entity (i.e., make/model of the vehicle), the inference server sends metadata, such as a bounding box of the detection, calculation metadata, confidence metadata, and/or identified entity name (the specific make and model of the vehicle) are sent to the webserver (e.g., the vehicle matching service). The inference server, as a pre-built software library, refers to the model file and provides prediction results, as the existing pattern correlates to a specific make and model of vehicle (e.g., using the matching algorithm as described herein).

The webserver stores the image in the frame used in the matching operation with the metadata received from the hardware processing node. The webserver then uses the stored metadata received from the hardware node, such as “Ford Bronco” or “Toyota Corolla,” and uses the metadata in a matching sequence. In some examples, this method will occur in combination with the plate detection method described herein, which will operate from a separate camera (non-thermal lens camera). At 340, the webserver stores the metadata and image in a database entry as a vehicle profile. In some examples, the metadata and image database entry may be used with the plate data entry from the vehicle identification service to run the matching algorithm. Specifically, data from the plate detection method described herein may be used with the data from the thermal camera method in the computer vision application described in FIG. 2 inside the web server and the matching algorithm to generate and/or identify the vehicle token and the vehicle profile. The identification of the vehicle make/model, and the identification of the alphanumeric plate can occur simultaneously or contemporaneously, and the identified data may be sent to the web server at the same time. The data may then be stored and input into the matching algorithm.

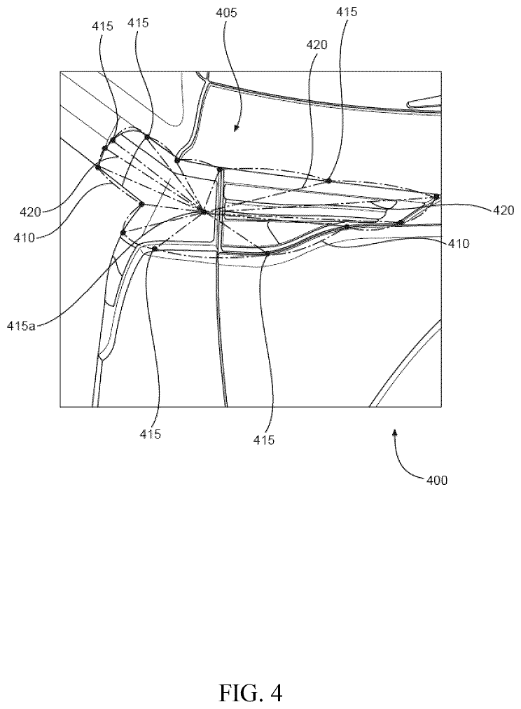

FIG. 4 shows an example of a fingerprint detection technique 400 that supports vehicle recognition systems and methods in accordance with aspects of the present disclosure. The fingerprint detection technique 400 may be an example of a vehicle identification procedure implemented by the vehicle identification service 145 of FIG. 1 and/or by the vehicle matching service 120 of FIG. 1. Vehicle video images at a specified frame rate may be received by a computer vision application (e.g., implemented by the vehicle identification service 145). For each frame received, the computer vision application checks the frame for a vehicle. Once a vehicle is detected, identifying features (e.g., taillight 405) of the vehicle are detected. The features may include various identifiable features including, but not limited to, taillights, bumper stickers, window color (tinted/non-tinted), roof racks, bike racks, vehicle height, dents/scratches, license plate position, license plate cover, and aftermarket parts (e.g., bumpers, exhaust tips, aero diffusers, spoilers, antennas, bar lights, camera, and other non-standard equipment).

As shown in FIG. 4, a perimeter line (e.g., perimeter line 410) is drawn around the perimeter of the feature. Multiple perimeter points (e.g., perimeter points 415) are drawn on the perimeter line (e.g., perimeter line 410) of each feature (e.g., taillight 405). A center point (e.g., center point 415a) is placed in the center of the feature (e.g., taillight 405). Center lines (e.g., center lines 420) are drawn from each perimeter point (e.g., point 415) to the center point (e.g., center point 415a) creating a mesh of the detected feature.

The identified features on the vehicle are referenced by distance from each perimeter point (e.g., perimeter points 415) and a ratio is created from each point to each point. The perimeter points may be drawn at various positions on the perimeter line so that the center lines may be drawn from various angles and distances. As a result, accurate measurements per each feature may be obtained and stored. A computer model infers and outputs a unique string of characters that will be replicable by the same point distance ratio.

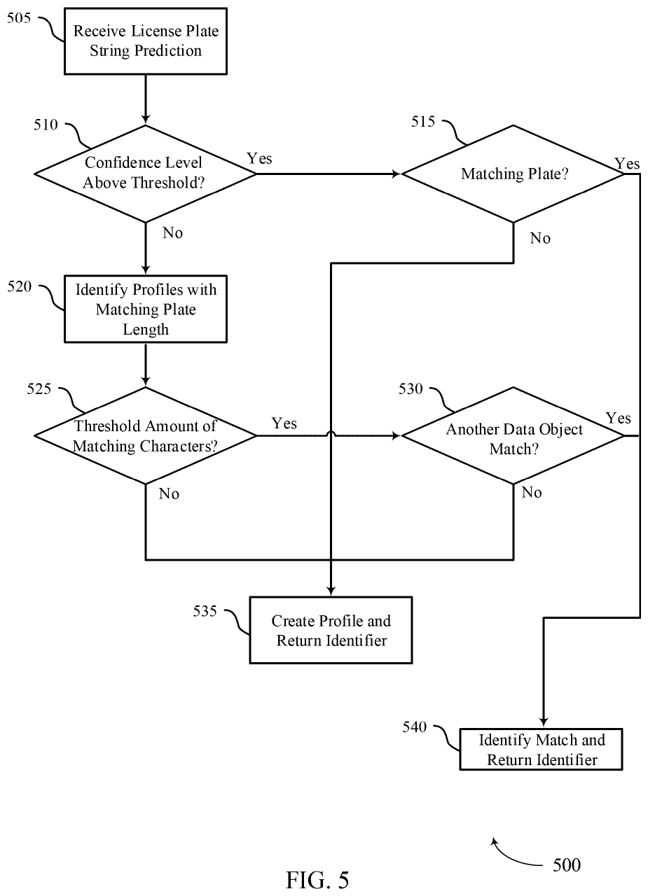

FIG. 5 shows an example of a flowchart 500 that supports vehicle recognition systems and methods in accordance with aspects of the present disclosure. The flowchart 500 may be implemented by a vehicle matching service as described herein. The flowchart 500 may illustrate example operations to support a matching algorithm to determine whether predicted data objects from an image of a vehicle matching a vehicle profile in a vehicle profile data store.

At 505, a predicted license plate string may be received from one or more vehicle identification services. The predicted license plate string may be received in addition to one or more other predicted data objects (e.g., make, model, color, year). The license plate string, make, model, color, year, may be predicted by various services using one or more of the various techniques described herein, such as image recognition, heat signature recognition, fingerprinting, etc. The predicted license plate string, in addition to the other predicted data objects, may be associated with a confidence level.

At 510, the vehicle matching service may determine whether the confidence level associated with the predicted license plate string is above a threshold (e.g., a 94% confidence level threshold). When the confidence level is above the threshold, then the vehicle matching service may, at 515, determine whether the predicted license plate string is found in one or more vehicle profiles from the vehicle profile data store. If the string is found in a profile, then the vehicle matching service may identify a match and return an identifier for the vehicle profile (e.g., a vehicle token). When the string is not found, then at 535, the vehicle matching service may create a new vehicle profile and assign a token to the profile. The token and/or another identifier for the vehicle may be returned.

When the confidence level is not above a threshold, then, at 520, the vehicle matching service may identify vehicle profiles, from the vehicle profile data store, with license plate strings having the same length as the predicted license plate string. At 525, the vehicle matching service may determine whether there is a threshold quantity of matching characters between the predicted license plate string and the license plate strings of the vehicle profiles that have the same length. The threshold amount may be dependent on the length. For example, if the length of the string is 8, then 6 characters may be the threshold quantity of characters to be matched. Other thresholds may be, for example, 5 of 7 characters, 4 of 6 characters, 7 of 9 characters, and 3 of 5 characters. When the threshold quantity of characters is matched, then, at 530, the vehicle matching service may determine whether one or more additional data objects match. For example, the vehicle matching service may determine whether there is a match between the predicted make, model, and/or color and the make, model and/or color of the vehicle profile with the threshold quantity of matched characters. When a match is detected, the vehicle matching service may identify the match and return the identifier at 540. Additionally, a partially read plate may be associated with the matched profile such as to more efficiently process the vehicle when the same partial plate is read at a subsequent time period. When there is no threshold matching quantity of characters or when there is no additional data object match then at 535, the vehicle matching service may determine that there is no match and create a new profile and assign a token to the profile at 535. The token and/or another identifier for the vehicle may be returned.

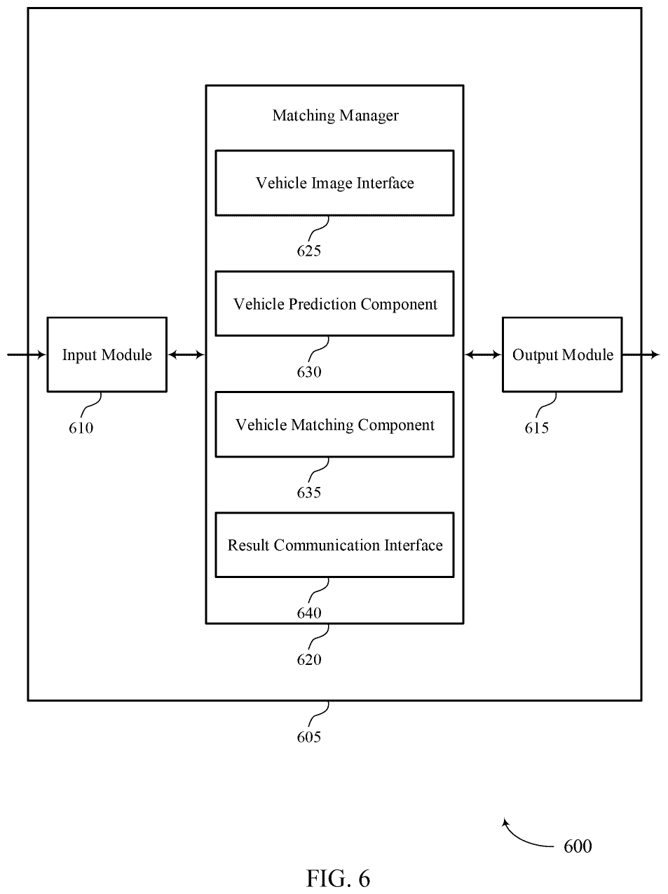

FIG. 6 shows a block diagram 600 of a device 605 that supports vehicle recognition systems and methods in accordance with aspects of the present disclosure. The device 605 may include an input module 610, an output module 615, and a matching manager 620. The device 605, or one or more components of the device 605 (e.g., the input module 610, the output module 615, the matching manager 620), may include at least one processor, which may be coupled with at least one memory, to support the described techniques. Each of these components may be in communication with one another (e.g., via one or more buses).

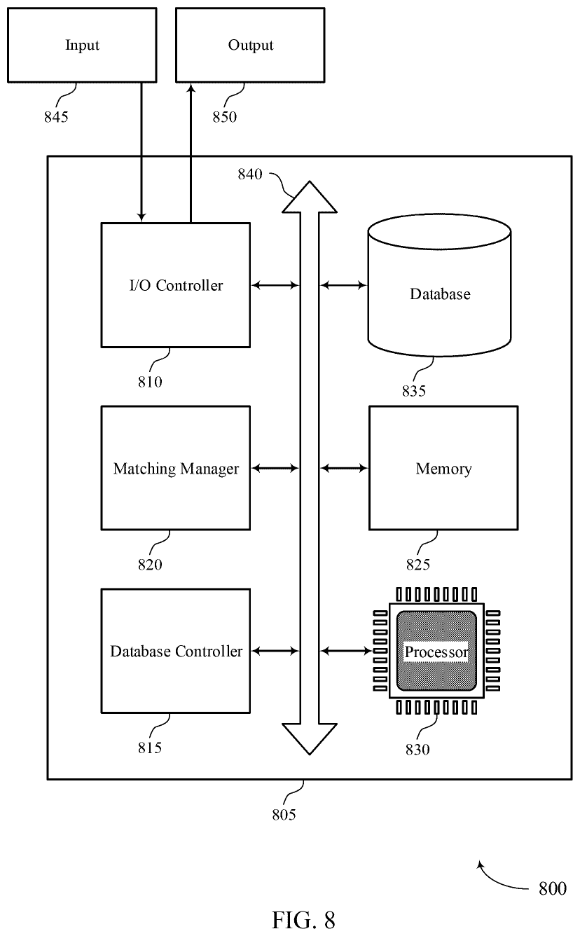

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the matching manager 620 to support vehicle recognition systems and methods. In some cases, the input module 610 may be a component of an input/output (I/O) controller 810 as described with reference to FIG. 8.

The output module 615 may manage output signals for the device 605. For example, the output module 615 may receive signals from other components of the device 605, such as the matching manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the matching manager 620 may include a vehicle image interface 625, a vehicle prediction component 630, a vehicle matching component 635, a result communication interface 640, or any combination thereof. In some examples, the matching manager 620, or various components thereof, may be configured to perform various operations (e.g., receiving, monitoring, transmitting) using or otherwise in cooperation with the input module 610, the output module 615, or both. For example, the matching manager 620 may receive information from the input module 610, send information to the output module 615, or be integrated in combination with the input module 610, the output module 615, or both to receive information, transmit information, or perform various other operations as described herein.

The matching manager 620 may support data processing in accordance with examples as disclosed herein. The vehicle image interface 625 may be configured to support receiving, at a server and from a computing device associated with at least one camera, at least one image of a vehicle detected in a vehicle detection zone during a first time period. The vehicle prediction component 630 may be configured to support generating, using the at least one image, a prediction of at least one data object associated with the vehicle. The vehicle matching component 635 may be configured to support determining whether the prediction of the at least one data object matches a vehicle profile from a vehicle profile data store. The result communication interface 640 may be configured to support communicating a result of determining whether the prediction of the at least one data object matches the vehicle profile.

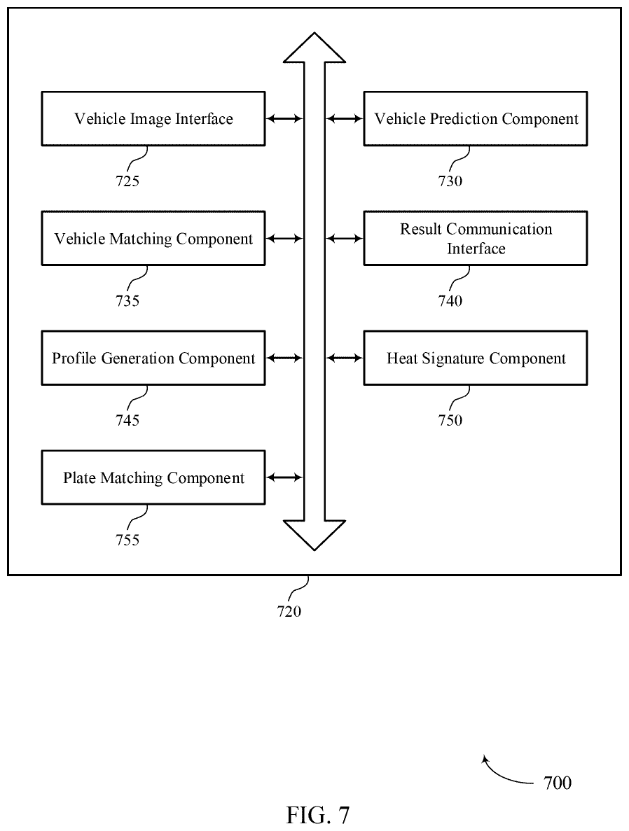

FIG. 7 shows a block diagram 700 of a matching manager 720 that supports vehicle recognition systems and methods in accordance with aspects of the present disclosure. The matching manager 720, or various components thereof, may be an example of means for performing various aspects of vehicle recognition systems and methods as described herein. For example, the matching manager 720 may include a vehicle image interface 725, a vehicle prediction component 730, a vehicle matching component 735, a result communication interface 740, a profile generation component 745, a heat signature component 750, a plate matching component 755, or any combination thereof. Each of these components, or components of subcomponents thereof (e.g., one or more processors, one or more memories), may communicate, directly or indirectly, with one another (e.g., via one or more buses).

The matching manager 720 may support data processing in accordance with examples, as disclosed herein. The vehicle image interface 725 may be configured to support receiving, at a server and from a computing device associated with at least one camera, at least one image of a vehicle detected in a vehicle detection zone during a first time period. The vehicle prediction component 730 may be configured to support generating, using the at least one image, a prediction of at least one data object associated with the vehicle. The vehicle matching component 735 may be configured to support determining whether the prediction of the at least one data object matches a vehicle profile from a vehicle profile data store. The result communication interface 740 may be configured to support communicating a result of determining whether the prediction of the at least one data object matches the vehicle profile.

In some examples, the profile generation component 745 may be configured to support creating, based on determining that the prediction of the at least one data object fails to match the vehicle profile, a new vehicle profile for the vehicle including at least one descriptor corresponding to the at least one data object. In some examples, the profile generation component 745 may be configured to support assigning a vehicle token to the vehicle profile, where communicating the result includes storing the vehicle profile in a data store.

In some examples, to support generating the prediction of the at least one data object, the vehicle prediction component 730 may be configured to support transmitting, to one or more vehicle identification services, the at least one image of the vehicle. In some examples, to support generating the prediction of the at least one data object, the vehicle prediction component 730 may be configured to support receiving, from the one or more vehicle identification services, a prediction of a license plate string identified from the at least one image, where the prediction includes the license plate string and a confidence score associated with the prediction of the license plate string.

In some examples, to support determining whether the prediction of the at least one data object matches the vehicle profile, the plate matching component 755 may be configured to support determining, based on the confidence score being greater than a threshold, whether the license plate string matches a license plate string in a set of multiple vehicle profiles in the vehicle profile data store.

In some examples, to support determining whether the prediction of the at least one data object matches the vehicle profile, the plate matching component 755 may be configured to support determining, that the confidence score is less than a threshold. In some examples, to support determining whether the prediction of the at least one data object matches the vehicle profile, the plate matching component 755 may be configured to support identifying a subset of vehicle profiles of a set of multiple vehicle profiles in the vehicle profile data store that have a license plate string length that matches a license plate string length of the predicted license plate string. In some examples, to support determining whether the prediction of the at least one data object matches the vehicle profile, the plate matching component 755 may be configured to support determining whether a threshold quantity of characters have matched between the predicted license plate string and respective license plate strings of the subset of vehicle profiles.

In some examples, the vehicle matching component 735 may be configured to support determining, based on a threshold quantity of characters being matched, whether at least one additional data object prediction from the at least one image of the vehicle and including a make, model, or color, matches corresponding data objects of the subset of vehicle profiles, where the at least one additional data object is received from the one or more vehicle identification services.

In some examples, the threshold quantity is based in part on the license plate string length.

In some examples, one or more vehicle identification services are configured to return a prediction of the make of the vehicle, the model of the vehicle, or both, using a vehicle identification procedure that the vehicle prediction component 730 may be configured to support which identifies a feature of the vehicle. In some examples, the one or more vehicle identification services may be configured to return a prediction of a make of the vehicle, a model of the vehicle, or both. The vehicle prediction component 730 may be configured to support drawing reference points on each feature. In some examples, the one or more vehicle identification services may be configured to return a prediction of a make of the vehicle, a model of the vehicle, or both, using a vehicle identification procedure. The vehicle prediction component 730 may be configured to measure respective distances between reference point pairs. In some examples, the one or more vehicle identification services are configured to return a prediction of the make of the vehicle, the model of the vehicle, or both, using a vehicle identification procedure. The vehicle prediction component 730 may be configured to support generating a point distance ratio from the measured respective distances. In some examples, the one or more vehicle identification services are configured to return a prediction of a make of the vehicle, a model of the vehicle, or both, using a vehicle identification procedure that may comprise the vehicle prediction component 730 being configured to support generating the prediction of the make, the model, or both, based on the point distance ratio.

In some examples, to support communicating the result, the result communication interface 740 may be configured to support transmitting, to the computing device, an identifier for the matched vehicle profile or an identifier for a generated new vehicle profile.

In some examples, to support generating the prediction, the heat signature component 750 may be configured to support detecting, based at least in part on one or more heat signatures included in the at least one image that includes a thermal image captured by the at least one camera that includes a thermal camera, identifiable features of the vehicle. In some examples, to support generating the prediction, the heat signature component 750 may be configured to support generating the prediction based on the identifiable features of the vehicle.

In some examples, the identifiable features include the hood structure of a hood of the vehicle.

In some examples, to support communicating the result, the result communication interface 740 may be configured to support communicating, to the computing device, an identifier for the vehicle, where the computing device is configured to perform one or more actions based on the identifier.

FIG. 8 shows a diagram of a system 800, including a device 805 that supports vehicle recognition systems and methods in accordance with aspects of the present disclosure. The device 805 may be an example of or include components of a device 605 as described herein. The device 805 may include components for bi-directional data communications, including components for transmitting and receiving communications, such as a matching manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may comprise a non-transitory computer-readable medium. The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting vehicle recognition systems and methods). The processor 830 may comprise a single processing core or multiple processing cores. For example, the device 805 may include one or more processors 830.

The matching manager 820 may support data processing in accordance with examples as disclosed herein. For example, the matching manager 820 may be configured to support receiving, at a server and from a computing device associated with at least one camera, at least one image of a vehicle detected in a vehicle detection zone during a first time period. The matching manager 820 may be configured to support generating, using the at least one image, a prediction of at least one data object associated with the vehicle. The matching manager 820 may be configured to support determining whether the prediction of the at least one data object matches a vehicle profile from a vehicle profile data store. The matching manager 820 may be configured to support communicating a result of determining whether the prediction of the at least one data object matches the vehicle profile.

By including or configuring the matching manager 820 in accordance with examples as described herein, the device 805 may support techniques for improved user experience related to reduced processing. That is, by offloading vehicle identification techniques from the edge (e.g., where the camera is located) and to the vehicle matching service, the vehicle matching service may efficiently identify and match vehicles to existing profiles, thereby enabling efficient action execution at the edge (e.g., opening a gate).

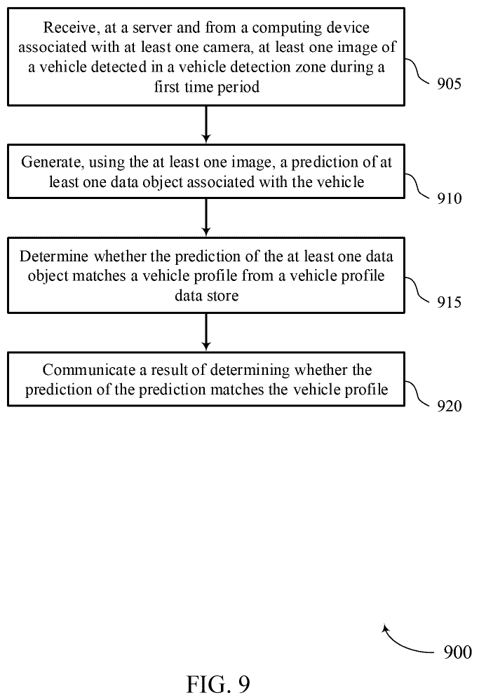

FIG. 9 shows a flowchart illustrating a method 900 that supports vehicle recognition systems and methods in accordance with aspects of the present disclosure. The operations of the method 900 may be implemented by the processor 830 or its components as described herein. For example, the operations of the method 900 may be performed by a vehicle matching server as described with reference to FIGS. 1 through 8. In some examples, the server 115 may execute a set of instructions to control the functional elements of the vehicle matching service 120 to perform the described functions. Additionally, or alternatively, the server 115 may perform aspects of vehicle matching using special-purpose hardware.

At 905, the method 900 may include receiving, at a server and from a computing device associated with at least one camera, at least one image of a vehicle detected in a vehicle detection zone during a first time period. In some examples, aspects of the operations of 905 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215. In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the image is selected based on a confidence score generated based on how clear the license plate text is, the amount of thermal data captured, and the recognition of identifying vehicle attributes.

In some embodiments, the computing device 110 may be communicatively coupled to a camera 105, which may capture at least one image and transfer it via a network to the vehicle matching server 115. In some embodiments, a network may be the internet, an intranet, or any other form of data transfer over a connected network.

At 910, the method 900 may include generating, using the at least one image, a prediction of at least one data object associated with the vehicle. The operations of 910 may be performed in accordance with examples as disclosed herein. In some examples, aspects of the operations of 910 may be performed by the vehicle prediction component 730 as described with reference to FIG. 7. In some embodiments, the vehicle prediction component 730 may identify features of the vehicle as a data object utilizing at least one of a single-shot multi-box detector (SSD), RetinaNet, you only look once (YOLO), region-based convolution neural network (R-CNN), Fast R-CNN, Mask R-CNN, or any combination thereof. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 915, the method 900 may include determining whether the prediction of the at least one data object matches a vehicle profile from a vehicle profile data store. The operations of 915 may be performed in accordance with examples as disclosed herein. In some examples, aspects of the operations of 915 may be performed by the vehicle matching component 735 as described with reference to FIG. 7. In some embodiments, the vehicle profile data store may be stored in profile data store 165, the memory 825, and/or the database 835. In some embodiments, the vehicle profile data may be stored as a structured document (e.g., HTML, XML, EXCEL, structured query language (SQL), and any other appropriate structured document format).

In some embodiments, the processor 830 may utilize an equality-based approach wherein the data records may be matched when some or all the attributes of the vehicle match the vehicle profile. For example, the vehicle profile data may contain the make, model, color, and license plate of a vehicle, and the processor 830 may have determined that the make, model, and license plate of the vehicle match the entry, but the color is not a match. The processor 830 may determine that the vehicle color is similar enough for a match since car colors can change due to lighting, cleanliness of the car, and new paint jobs; thus, the vehicle is a predicted match for the vehicle profile since the remaining attributes match.

In some embodiments, the processor 830 may use a pairwise comparison to determine when the vehicle matches a vehicle profile. In some embodiments, the processor 830 may utilize deterministic record linkages where weights are assigned to each field and similarity scores are calculated based on a set of defined rules to determine whether a vehicle matches a vehicle profile. For example, the license plate field may be given a high weight, so a match of a license plate string between the vehicle and a vehicle profile is more likely to be a match.

At 920, the method 900 may include communicating a result of determining whether the prediction of the at least one data object matches the vehicle profile. The operations of 920 may be performed in accordance with examples as disclosed herein. In some examples, aspects of the operations of 920 may be performed by the result communication interface 740 as described with reference to FIG. 7. In some embodiments, the result communication interface 740 may output the result via a display, an auditory output, haptic feedback, a notification to a client computing device, or some combination thereof.

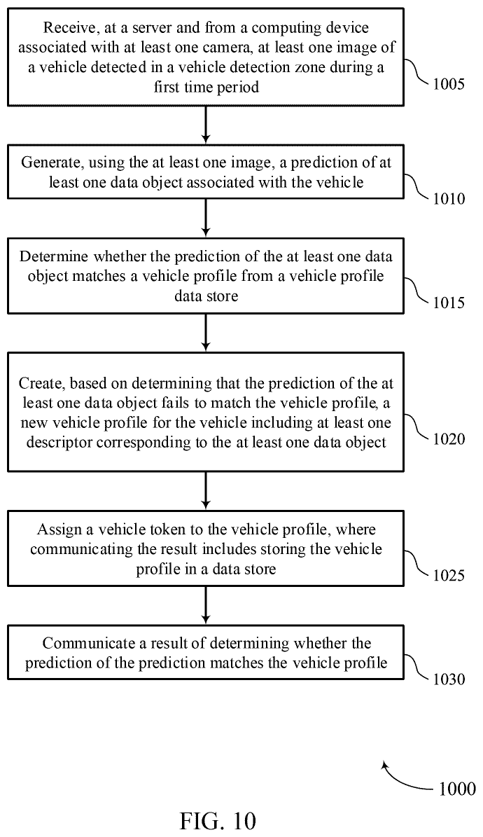

FIG. 10 shows a flowchart illustrating a method 1000 that supports vehicle recognition systems and methods in accordance with aspects of the present disclosure. The operations of the method 1000 may be implemented by the processor 830 or its components as described herein. For example, the operations of the method 1000 may be performed by a vehicle matching server 115 as described with reference to FIGS. 1 through 8. In some examples, a vehicle matching server 115 may execute a set of instructions to control the functional elements of the vehicle matching server to perform the described functions. Additionally, or alternatively, the vehicle matching server 115 may perform aspects of the described functions using special-purpose hardware.

At 1005, the method 1000 may include receiving, at a server and from a computing device associated with at least one camera, at least one image of a vehicle detected in a vehicle detection zone during a first time period. The operations of 1005 may be performed in accordance with examples as disclosed herein. In some examples, aspects of the operations of 1005 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215. In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the sample image is selected based on a confidence score generated based on how clear the license plate text is, the amount of thermal data captured, and the recognition of identifying vehicle attributes.

In some embodiments, the computing device 110 may be communicatively coupled to a camera 105, which may capture at least one image and transfer it via a network to the vehicle matching server 115. In some embodiments, a network may be the internet, an intranet, or any other form of data transfer over a connected network.

At 1010, the method 1000 may include generating, using the at least one image, a prediction of at least one data object associated with the vehicle. The operations of 1010 may be performed in accordance with examples as disclosed herein. In some examples, aspects of the operations of 1010 may be performed by the vehicle prediction component 730 as described with reference to FIG. 7. In some embodiments, the vehicle prediction component 730 may recognize data objects associated with the vehicle utilizing at least one of a single-shot multi-box detector (SSD), RetinaNet, you only look once (YOLO), region-based convolution neural network (R-CNN), Fast R-CNN, Mask R-CNN, or any combination thereof. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 1015, the method 1000 may include determining whether the prediction of the at least one data object matches a vehicle profile from a vehicle profile data store. The operations of 1015 may be performed in accordance with examples as disclosed herein. In some examples, aspects of the operations of 1015 may be performed by the vehicle matching component 735 as described with reference to FIG. 7. In some embodiments, the vehicle profile data store may be stored in profile data store 165, the memory 825, and/or the database 835. In some embodiments, the vehicle profile data may be stored as a structured document (e.g., HTML, XML, EXCEL, structured query language (SQL), and any other appropriate structured document format).

In some embodiments, the processor 830 may utilize an equality-based approach wherein the data records may be matched if some or all the attributes of the vehicle match the vehicle profile. For example, the vehicle profile data may contain the make, model, color, and license plate of a vehicle, and the processor 830 may have determined that the make, model, and license plate of the vehicle match the entry, but the color is not a match. The processor 830 may determine that the vehicle color is similar enough for a match since car colors can change due to lighting, cleanliness of the car, and new paint jobs; thus, the vehicle may be a predicted match for the vehicle profile since the remaining attributes match.

In some embodiments, the processor 830 may use a pairwise comparison to determine if the vehicle matches a vehicle profile. In some embodiments, the processor 830 may utilize deterministic record linkages where weights are assigned to each field and similarity scores are calculated based on a set of defined rules to determine whether a vehicle is a match to a vehicle profile. For example, the license plate field may be given a high weight, so a match of a license plate string between the vehicle and a vehicle profile is more likely to be a match.

At 1020, the method 1000 may include creating, based on determining that the prediction of the at least one data object fails to match the vehicle profile, a new vehicle profile for the vehicle including at least one descriptor corresponding to the at least one data object. The operations of 1020 may be performed in accordance with examples as disclosed herein. In some examples, aspects of the operations of 1020 may be performed by the profile generation component 745 as described with reference to FIG. 7. In some embodiments, the processor 830 may generate a matching score between the vehicle and all the vehicle profiles stored in the database 835 and/or the memory 825. In some embodiments, when the confidence scores are all below a predetermined threshold, the processor 830 may determine that none of the vehicle profiles sufficiently match the vehicle.

In some embodiments, the processor 830 may, after determining no record among the vehicle profiles sufficiently matches the vehicle, generate a new vehicle profile based on the vehicle. For example, the processor 830 may create a new entry in the structured document storing the vehicle profiles and populate that entry with the one or more identified vehicle features (e.g., a license plate string, a vehicle make, a vehicle model, a vehicle color, a vehicle year, vehicle after-market components, vehicle accessories, vehicle heat pattern, or any identifying feature of the vehicle).

At 1025, the method 1000 may include assigning a vehicle token to the vehicle profile, where communicating the result includes storing the vehicle profile in a data store. The operations of 1025 may be performed in accordance with examples as disclosed herein. In some examples, aspects of the operations of 1025 may be performed by a profile generation component 745 as described with reference to FIG. 7. In some embodiments, the vehicle token is generated by a third-party server, wherein the token is generated based on multiple fields related to the vehicle and may include the identified vehicle features. In some embodiments, the token generated by the third-party server may be stored at the database 835 and/or the memory 825.

In some embodiments, tokens may be used for authentication, where the token, rather than traditional user IDs and passwords, are used to verify a user's identity. The token may encapsulate both the user's identity and proof of that identity, making it a single, secure entity. When a user attempts to connect to a server, the token generated by an external application or third-party provider is passed as input. The token can support single sign-on (SSO), allowing users to access multiple services with just one token, simplifying the login experience. In some embodiments, the server can directly validate the contents of the token to authenticate the user, ensuring secure access. Additionally, security plug-ins that use the Generic Security Services Application Program Interface (GSSAPI) can also accept the token as input.

At 1030, the method 1000 may include communicating a result of determining whether the prediction of the at least one data object matches the vehicle profile. The operations of 1030 may be performed in accordance with examples as disclosed herein. In some examples, aspects of the operations of 1030 may be performed by the result communication interface 740 as described with reference to FIG. 7. In some embodiments, the result communication interface 740 may output the result via a display, an auditory output, haptic feedback, a notification to a client computing device, or some combination thereof.

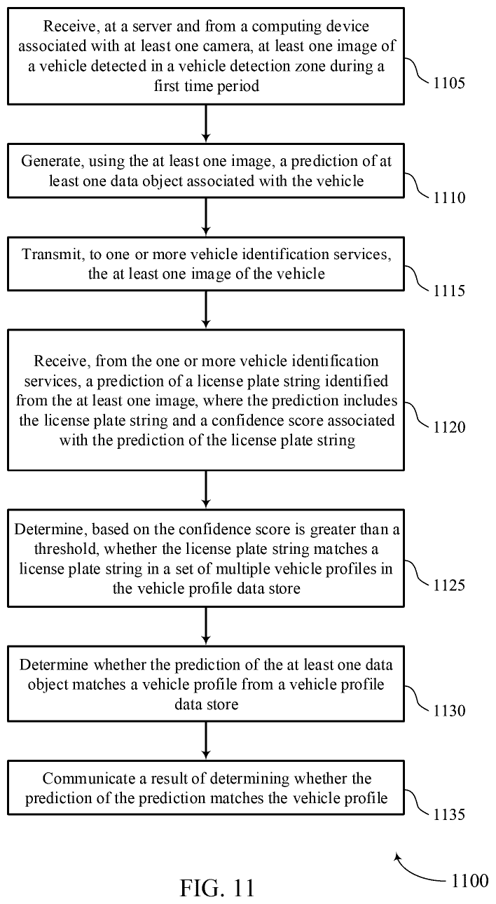

FIG. 11 shows a flowchart illustrating a method 1100 that supports the vehicle recognition systems and methods in accordance with aspects of the present disclosure. The operations of the method 1100 may be implemented by the processor 830 or its components as described herein. For example, the operations of the method 1100 may be performed by the vehicle matching server 115 as described with reference to FIGS. 1 through 8. In some examples, the processor 830 may execute a set of instructions to control the functional elements of the vehicle matching server to perform the described functions. Additionally, or alternatively, the processor 830 may perform aspects of the described functions using special-purpose hardware.

At 1105, the method 1100 may include receiving, at a server and from a computing device associated with at least one camera, at least one image of a vehicle detected in a vehicle detection zone during a first time period. The operations of 1105 may be performed in accordance with examples as disclosed herein. In some examples, aspects of the operations of 1105 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215.

In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the same image is selected based on a confidence score generated based on how clear the license plate text is, the amount of thermal data captured, and the recognition of identifying vehicle attributes.

At 1110, the method 1100 may include generating, using the at least one image, a prediction of at least one data object associated with the vehicle. The operations of 1110 may be performed in accordance with examples as disclosed herein. In some examples, aspects of the operations of 1110 may be performed by the vehicle prediction component 730 as described with reference to FIG. 7. In some embodiments, the vehicle prediction component 730 may recognize data objects associated with the vehicle utilizing at least one of a single-shot multi-box detector (SSD), RetinaNet, you only look once (YOLO), region-based convolution neural network (R-CNN), Fast R-CNN, Mask R-CNN, or any combination thereof. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 1115, the method 1100 may include transmitting, to one or more vehicle identification services, the at least one image of the vehicle. The operations of 1115 may be performed in accordance with examples as disclosed herein. In some examples, aspects of the operations of 1115 may be performed by a vehicle prediction component 730 as described with reference to FIG. 7. In some embodiments, the computing device 110 may be communicatively coupled to a camera 105, which may capture at least one image and transfer it via a network to the vehicle matching server 115. In some embodiments, a network may be the internet, an intranet, or any other form of data transfer over a connected network.

At 1120, the method 1100 may include receiving, from the one or more vehicle identification services, a prediction of a license plate string identified from the at least one image, where the prediction includes the license plate string and a confidence score associated with the prediction of the license plate string. The operations of 1120 may be performed in accordance with examples as disclosed herein. In some examples, aspects of the operations of 1120 may be performed by the vehicle prediction component 730 as described with reference to FIG. 7. In some embodiments, the one or more vehicle identification services may be managed from a third-party server communicatively coupled to the processor 830 via a network (e.g., the Internet).

In some embodiments, optical character recognition (OCR) may be used to predict the license plate string from the at least one image. For example, the processor 830 may utilize a pattern-matching algorithm to isolate each character of the license plate string and compare each character, pixel by pixel, to stored templates of characters. Based on the level of matching between each character and its matching character template, a confidence score may be generated, indicating the level of confidence that the predicted license plate string is accurate.

In some embodiments, the processor 830 may utilize a feature extraction algorithm to break down glyphs into more basic features such as angled lines, intersections, and curves, which may make identification more computationally efficient than the pattern-matching algorithm. In some embodiments, machine learning may be used to compare the identified features to a stored template of characters in order to identify a match. Based on the level of matching between each character and its matching character template, a confidence score may be generated, indicating the level of confidence that the predicted license plate string is accurate.

In some embodiments, the processor 830 may send the one or more image of the vehicle to a third-party server having an OCR service such as, but not limited to, EasyOCR, PaddleOCR, Kraken, Calamari OCR, AMAZON Textract/Rekognition, ChatGPT, Gemini, Claude, or any available service offering OCR functionality.

At 1125, the method 1100 may include determining, based on the confidence score being greater than a threshold, whether the license plate string matches a license plate string in a set of multiple vehicle profiles in the vehicle profile data store. The operations of 1125 may be performed in accordance with examples as disclosed herein. In some examples, aspects of the operations of 1125 may be performed by the plate matching component 755 as described with reference to FIG. 7. In some embodiments, a threshold may be stored to determine when the confidence score generated during the OCR of the vehicle image is satisfactory. In some embodiments, when the confidence score is below a threshold a different OCR process may be used. In some embodiments, when no available OCR process provides a resulting confidence score that is above the threshold, then a new image of the vehicle may be utilized.

At 1130, the method 1100 may include determining whether the prediction of the at least one data object matches a vehicle profile from a vehicle profile data store. The operations of 1130 may be performed in accordance with examples as disclosed herein. In some examples, aspects of the operations of 1130 may be performed by the vehicle matching component 735 as described with reference to FIG. 7. In some embodiments, the vehicle profile data store may be stored in profile data store 165, the memory 825, and/or the database 835. In some embodiments, the vehicle profile data may be stored as a structured document (e.g., HTML, XML, EXCEL, structured query language (SQL), and any other appropriate structured document format).

In some embodiments, the processor 830 may, to determine a match, utilize an equality-based approach wherein the data records may be matched when some or all the attributes of the vehicle match the vehicle profile. For example, the vehicle profile data may contain the make, model, color, and license plate of a vehicle, and the processor 830 may have determined that the make, model, and license plate of the vehicle match the entry, but the color is not a match. The processor 830 may determine that the vehicle color is similar enough for a match since car colors can change due to lighting, cleanliness of the car, and new paint jobs; thus, the vehicle may be a predicted match for the vehicle profile since the remaining attributes match.

In some embodiments, the processor 830 may use a pairwise comparison to determine whether the vehicle matches a vehicle profile. In some embodiments, the processor 830 may utilize deterministic record linkages where weights are assigned to each field and similarity scores are calculated based on a set of defined rules to determine whether a vehicle matches a vehicle profile. For example, the license plate field may be given a high weight, so a match of a license plate string between the vehicle and a vehicle profile is more likely to be a match.

At 1135, the method 1100 may include communicating a result of determining whether the prediction of the at least one data object matches the vehicle profile. The operations of 1135 may be performed in accordance with examples as disclosed herein. In some examples, aspects of the operations of 1135 may be performed by the result communication interface 740 as described with reference to FIG. 7. In some embodiments, the result communication interface 740 may output the result via a display, an auditory output, haptic feedback, a notification to a client computing device, or some combination thereof.

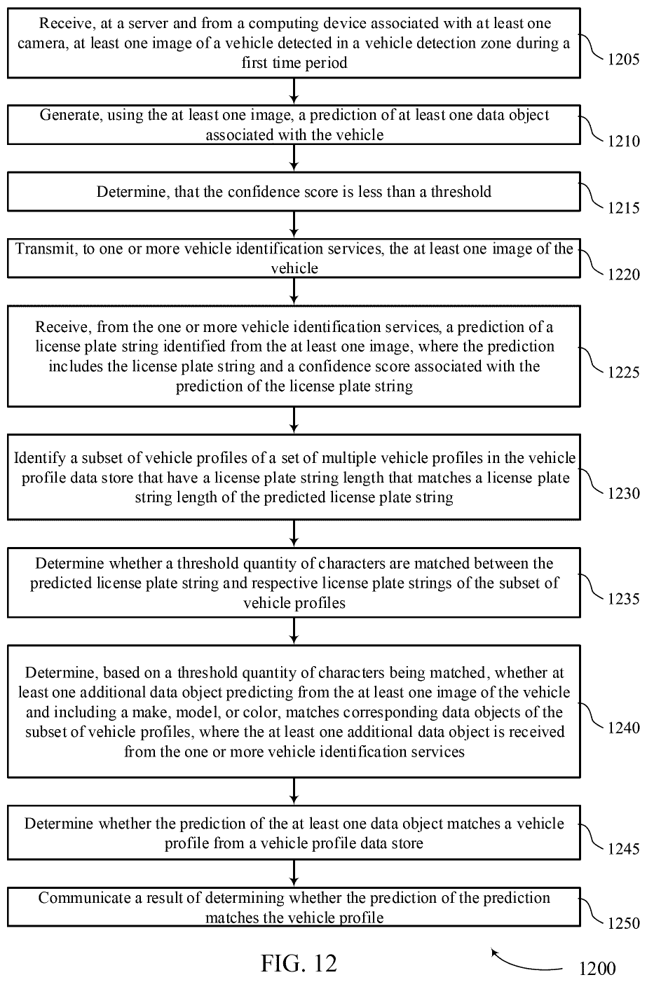

FIG. 12 shows a flowchart illustrating a method 1200 that supports vehicle recognition systems and methods in accordance with aspects of the present disclosure. The operations of the method 1200 may be implemented by a vehicle matching server or its components as described herein. For example, the operations of the method 1200 may be performed by the processor 830 as described with reference to FIGS. 1 through 8. In some examples, the processor 830 may execute a set of instructions to control the functional elements of the vehicle matching server 115 to perform the described functions. Additionally, or alternatively, the vehicle matching server 115 may perform aspects of the described functions using special-purpose hardware.

At 1205, the method 1200 may include receiving, at a server and from a computing device associated with at least one camera, at least one image of a vehicle detected in a vehicle detection zone during a first time period. The operations of 1205 may be performed in accordance with examples as disclosed herein. In some examples, aspects of the operations of 1205 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215.

In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the same image is selected based on a confidence score generated based on how clear the license plate text is, the amount of thermal data captured, and the recognition of identifying vehicle attributes.

At 1210, the method 1200 may include generating, using the at least one image, a prediction of at least one data object associated with the vehicle. The operations of 1210 may be performed in accordance with examples as disclosed herein. In some examples, aspects of the operations of 1210 may be performed by the vehicle prediction component 730 as described with reference to FIG. 7. In some embodiments, the vehicle prediction component 730 may recognize data objects associated with the vehicle utilizing at least one of a single-shot multi-box detector (SSD), RetinaNet, you only look once (YOLO), region-based convolution neural network (R-CNN), Fast R-CNN, Mask R-CNN, or any combination thereof.

In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle. In some embodiments, the vehicle prediction component 730 may generate a confidence score for each entry of a vehicle profile wherein the confidence score indicates the level of similarity between the vehicle and each vehicle profile.

At 1215, the method 1200 may include determining, that the confidence score is less than a threshold. The operations of 1215 may be performed in accordance with examples as disclosed herein. In some examples, aspects of the operations of 1215 may be performed by the plate matching component 755 as described with reference to FIG. 7. In some embodiments, the confidence score of the object recognition process may be used to compare to a threshold. In some embodiments, the confidence score of the character recognition process may be used to compare to a threshold. In some embodiments, a combination of the object recognition process and the character recognition process is used.

At 1220, the method 1200 may include transmitting, to one or more vehicle identification services, the at least one image of the vehicle. The operations of 1220 may be performed in accordance with examples as disclosed herein. In some examples, aspects of the operations of 1220 may be performed by the vehicle prediction component 730 as described with reference to FIG. 7. In some embodiments, the processor 830 may transmit the one or more images to a third-party server via a network (e.g., the Internet).

At 1225, the method 1200 may include identifying a subset of vehicle profiles of a set of multiple vehicle profiles in the vehicle profile data store that have a license plate string length that matches a license plate string length of the predicted license plate string. The operations of 1225 may be performed in accordance with examples as disclosed herein. In some examples, aspects of the operations of 1225 may be performed by a plate matching component 755 as described with reference to FIG. 7. In some embodiments, the processor 830 may send the one or more image of the vehicle to a third-party server having an OCR service such as, but not limited to, EasyOCR, PaddleOCR, Kraken, Calamari OCR, AMAZON Textract/Rekognition, ChatGPT, Gemini, Claude, or any available service offering OCR functionality. In some embodiments, the third party identification service may generate a confidence score for each entry of a vehicle profile wherein the confidence score indicates the confidence level that the predicted text string is accurate.

At 1230, the method 1200 may include receiving, from the one or more vehicle identification services, a prediction of a license plate string identified from the at least one image, where the prediction includes the license plate string and a confidence score associated with the prediction of the license plate string. The operations of 1230 may be performed in accordance with examples as disclosed herein. In some examples, aspects of the operations of 1230 may be performed by the vehicle prediction component 730 as described with reference to FIG. 7. In some embodiments, the processor 830 may rank the vehicle profiles by comparing the predicted text string to the license plate string in each vehicle profile. In some embodiments, a subset may be chosen based on a top percentage of vehicle to vehicle profile matches. For example, a predetermined top percentage may be 10%, wherein the top 10% highest scoring matches are selected as the subset. In some embodiments, other percentages can be selected by the user (e.g., 5%, 25%, 50%, etc.).

In some embodiments, the subset may be chosen based on the number of characters in the license plate string. For example, when the prediction of the license plate string includes six characters, the subset is created based on vehicle profiles having license plate strings of six characters.

In some embodiments, the confidence score of the OCR of the license plate text string of the vehicle may affect the weight assigned to the license plate text string field. For example, when the confidence score of the identification of the license plate text string is below a threshold, then the processor 830 may proportionally lower the weight related to the license plate text string, so a mismatch of the license plate string has a lower impact on the process of matching the vehicle with a vehicle profile.

At 1235, the method 1200 may include determining whether a threshold quantity of characters are matched between the predicted license plate string and respective license plate strings of the subset of vehicle profiles. The operations of 1235 may be performed in accordance with examples as disclosed herein. In some examples, aspects of the operations of 1235 may be performed by the plate matching component 755 as described with reference to FIG. 7.

In some embodiments, the threshold may be preset or preselected by the user. For example, for a user operating in a jurisdiction where license plate strings have seven digits, the threshold may be four, wherein matching at least four characters of a predicted vehicle string to a vehicle profile is sufficient to indicate a match.

In some embodiments, the OCR process may generate a confidence score for each individual character and use the individual character confidence scores for the matching process. In some embodiments, there may be a weight associated with the matching of each individual character wherein a more significant weight is afforded to matching a character with a high level of confidence in the OCR, and a lower weight is afforded to matching a character with a low level of confidence.

At 1240, the method 1200 may include determining, based on a threshold quantity of characters being matched, whether at least one additional data object prediction from the at least one image of the vehicle and including a make, model, or color, matches corresponding data objects of the subset of vehicle profiles, where the at least one additional data object is received from the one or more vehicle identification services. The operations of 1240 may be performed in accordance with examples as disclosed herein. In some examples, aspects of the operations of 1240 may be performed by the vehicle matching component 735 as described with reference to FIG. 7. In some embodiments, the vehicle matching component 735 may receive recognition of data objects associated with the vehicle utilizing at least one of API4AI, AMAZON Rekognition, CHOOCH AI, CLARIFAI, GOOGLE Cloud Vision API, Visua AI, IMAGGA, MICROSOFT Azure, SENTISIGHT.AI, HIVE object detection API, or any appropriate object detection service. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 1245, the method 1200 may include determining whether the prediction of the at least one data object matches a vehicle profile from a vehicle profile data store. The operations of 1245 may be performed in accordance with examples as disclosed herein. In some examples, aspects of the operations of 1245 may be performed by the vehicle matching component 735 as described with reference to FIG. 7.

In some embodiments, the processor 830 may utilize an equality-based approach wherein the data records may be matched when some or all the attributes of the vehicle match the vehicle profile. For example, the vehicle profile data may contain the make, model, color, and license plate of a vehicle, and the processor 830 may have determined that the make, model, and license plate of the vehicle match the entry, but the color is not a match. The processor 830 may determine that the vehicle color is similar enough for a match since car colors can change due to lighting, cleanliness of the car, and new paint jobs; thus, the vehicle is a predicted match for the vehicle profile since the remaining attributes match.

In some embodiments, the processor 830 may use a pairwise comparison to determine when the vehicle matches a vehicle profile. In some embodiments, the processor 830 may utilize deterministic record linkages where weights are assigned to each field and similarity scores are calculated based on a set of defined rules to determine when a vehicle is a match to a vehicle profile. For example, the license plate field may be given a high weight so a match of a license plate string between the vehicle and a vehicle profile is more likely to be a match.

At 1250, the method 1200 may include communicating a result of determining whether the prediction of the at least one data object matches the vehicle profile. The operations of 1250 may be performed in accordance with examples as disclosed herein. In some examples, aspects of the operations of 1250 may be performed by the result communication interface 740 as described with reference to FIG. 7. In some embodiments, the result communication interface 740 may output the result via a display, an auditory output, haptic feedback, a notification to a client computing device, or some combination thereof.

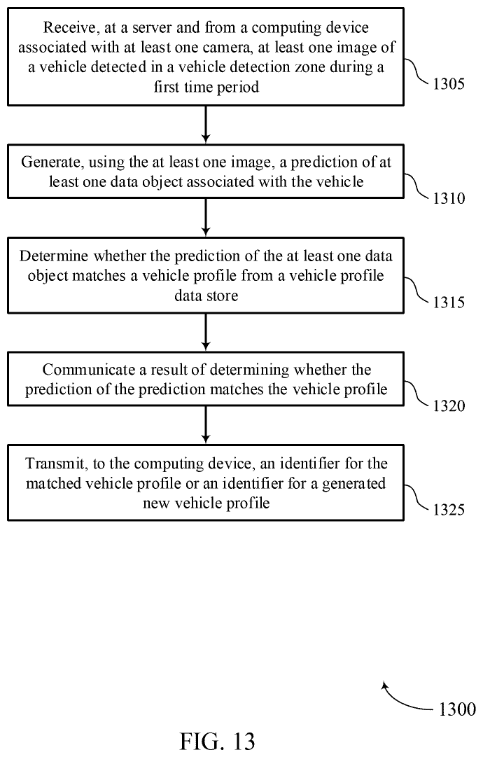

FIG. 13 shows a flowchart illustrating a method 1300 that supports vehicle recognition systems and methods in accordance with aspects of the present disclosure. The operations of the method 1300 may be implemented by the processor 830 or its components as described herein. For example, the operations of the method 1300 may be performed by the vehicle matching server 115 as described with reference to FIGS. 1 through 8. In some examples, the processor 830 may execute a set of instructions to control the functional elements of the vehicle matching server 115 to perform the described functions. Additionally, or alternatively, the vehicle matching server 115 may perform aspects of the described functions using special-purpose hardware.

At 1305, the method 1300 may include receiving, at a server and from a computing device associated with at least one camera, at least one image of a vehicle detected in a vehicle detection zone during a first time period. The operations of 1305 may be performed in accordance with examples as disclosed herein. In some examples, aspects of the operations of 1305 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215. In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the sample image may be selected based on a confidence score generated based on how clear the license plate text is, the amount of thermal data captured, and the recognition of identifying vehicle attributes.

In some embodiments, the computing device 110 may be communicatively coupled to a camera 105, which may capture at least one image and transfer the image via a network to the vehicle matching server 115. In some embodiments, a network may be the internet, an intranet, or any other form of data transfer over a connected network.

At 1310, the method 1300 may include generating, using the at least one image, a prediction of at least one data object associated with the vehicle. The operations of 1310 may be performed in accordance with examples as disclosed herein. In some examples, aspects of the operations of 1310 may be performed by the vehicle prediction component 730 as described with reference to FIG. 7. In some embodiments, the vehicle prediction component 730 may recognize data objects associated with the vehicle utilizing at least one of a single-shot multi-box detector (SSD), RetinaNet, you only look once (YOLO), region-based convolution neural network (R-CNN), Fast R-CNN, Mask R-CNN, or any combination thereof. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 1315, the method 1300 may include determining whether the prediction of the at least one data object matches a vehicle profile from a vehicle profile data store. The operations of 1315 may be performed in accordance with examples as disclosed herein. In some examples, aspects of the operations of 1315 may be performed by the vehicle matching component 735 as described with reference to FIG. 7. In some embodiments, the vehicle profile data store may be stored in profile data store 165, the memory 825, and/or the database 835. In some embodiments, the vehicle profile data may be stored as a structured document (e.g., HTML, XML, EXCEL, structured query language (SQL), and any other appropriate structured document format).

In some embodiments, the processor 830 may utilize an equality-based approach wherein the data records may be matched when some or all the attributes of the vehicle match the vehicle profile. For example, the vehicle profile data may contain the make, model, color, and license plate of a vehicle, and the processor 830 may have determined that the make, model, and license plate of the vehicle match the entry, but the color is not a match. The processor 830 may determine that the vehicle color is similar enough for a match since car colors can change due to lighting, cleanliness of the car, and new paint jobs; thus, the vehicle may be a predicted match for the vehicle profile since the remaining attributes match.

In some embodiments, the processor 830 may use a pairwise comparison to determine if the vehicle matches a vehicle profile. In some embodiments, the processor 830 may utilize deterministic record linkages where weights are assigned to each field and similarity scores are calculated based on a set of defined rules to determine when a vehicle is a match to a vehicle profile. For example, the license plate field may be given a high weight so a match of a license plate string between the vehicle and a vehicle profile is more likely to be a match.

At 1320, the method 1300 may include communicating a result of determining whether the prediction of the at least one data object matches the vehicle profile. The operations of 1320 may be performed in accordance with examples as disclosed herein. In some examples, aspects of the operations of 1320 may be performed by the result communication interface 740 as described with reference to FIG. 7. In some embodiments, the result communication interface 740 may output the result via a display, an auditory output, haptic feedback, a notification to a client computing device, or some combination thereof.

At 1325, the method 1300 may include transmitting, to the computing device, an identifier for the matched vehicle profile or an identifier for a generated new vehicle profile. The operations of 1325 may be performed in accordance with examples as disclosed herein. In some examples, aspects of the operations of 1325 may be performed by a result communication interface 740 as described with reference to FIG. 7. In some embodiments, the identifier of the vehicle profile is a unique token which represents the vehicle profile. In some embodiments, each vehicle profile may be associated with a unique token wherein the processor 380 may reference any vehicle profile by the token associated with the vehicle profile. In some embodiments, the token may be generated as a non-sensitive equivalent reference to a vehicle profile wherein the token alone has no extrinsic or exploitable value.

In some embodiments, the token may be encrypted to secure data so that only authorized parties can access the information. In this process, the token may be encrypted using an asymmetric public key. This public key may be configured in a server, which is responsible for issuing the tokens. In some embodiments, when the token is issued, the server may use the public key to encrypt the token, ensuring that the token's contents are protected from unauthorized access during transmission. Once the token reaches the client server, the token may be decrypted using a corresponding private key. This private key may be securely held by the client server and is the only key that can decrypt the data encrypted with the public key. By using this process, the client server may ensure that the vehicle profile associated with the token remains confidential and can only be read by the intended recipient, enhancing the overall security of the authentication process.

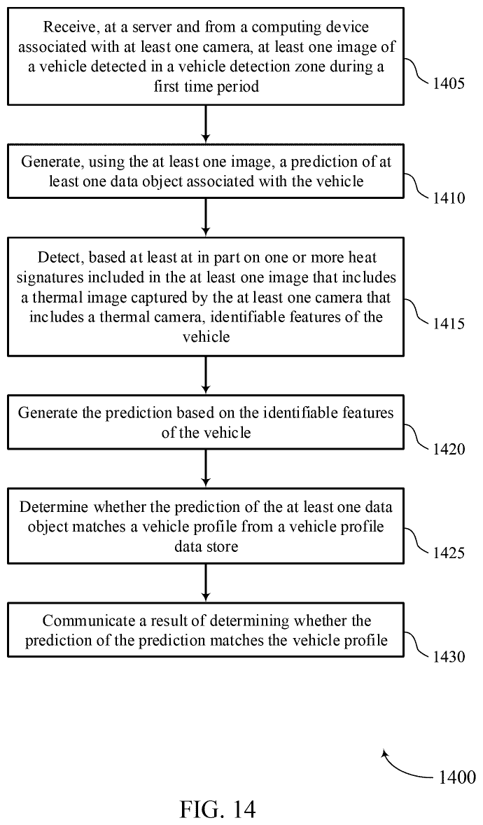

FIG. 14 shows a flowchart illustrating a method 1400 that supports vehicle recognition systems and methods in accordance with aspects of the present disclosure. The operations of the method 1400 may be implemented by the processor 380, as described herein. For example, the operations of the method 1400 may be performed by the vehicle matching server 115 as described with reference to FIGS. 1 through 8. In some examples, the processor 830 may execute a set of instructions to control the functional elements of the vehicle matching server 115 to perform the described functions. Additionally, or alternatively, the vehicle matching server 115 may perform aspects of the described functions using special-purpose hardware.

At 1405, the method 1400 may include receiving, at a server and from a computing device associated with at least one camera, at least one image of a vehicle detected in a vehicle detection zone during a first time period. The operations of 1405 may be performed in accordance with examples as disclosed herein. In some examples, aspects of the operations of 1405 may be performed by the vehicle image interface 725 as described with reference to FIG. 7. In some embodiments, the camera 105 may capture a series of images of the vehicle as it maneuvers through the vehicle detection zone. In some embodiments, the processor 830 may transmit the series of images to the vehicle matching service 215. In some embodiments, the processor 830 may select a sample image from the series of images captured by the camera 105 based on one or more metrics (e.g., clarity, angle, lighting conditions, vividness, contrast, definition, crispness, focus, accuracy, and brightness). In some embodiments, the same image is selected based on a confidence score generated based on how clear the license plate text is, the amount of thermal data captured, and the recognition of identifying vehicle attributes.

In some embodiments, the computing device 110 may be communicatively coupled to a camera 105, which may capture at least one image and transfer it via a network to the vehicle matching server 115. In some embodiments, a network may be the internet, an intranet, or any other form of data transfer over a connected network.

At 1410, the method 1400 may include generating, using the at least one image, a prediction of at least one data object associated with the vehicle. The operations of 1410 may be performed in accordance with examples as disclosed herein. In some examples, aspects of the operations of 1410 may be performed by the vehicle prediction component 730 as described with reference to FIG. 7. In some embodiments, the vehicle prediction component 730 may recognize data objects associated with the vehicle utilizing at least one of a single-shot multi-box detector (SSD), RetinaNet, you only look once (YOLO), region-based convolution neural network (R-CNN), Fast R-CNN, Mask R-CNN, or any combination thereof. In some embodiments, the data object associated with the vehicle may comprise a license plate string, a vehicle make, a vehicle model, a vehicle color, a vehicle year, vehicle after-market components, vehicle accessories, vehicle heat pattern, or any identifying feature of the vehicle.

At 1415, the method 1400 may include detecting, based at least at in part on one or more heat signatures included in the at least one image that includes a thermal image captured by the at least one camera that includes a thermal camera, identifiable features of the vehicle. The operations of 1415 may be performed in accordance with examples as disclosed herein. In some examples, aspects of the operations of 1415 may be performed by the heat signature component 750 as described with reference to FIG. 7. In some embodiments, the processor 830 may receive one or more thermal images from a thermal camera.

In some embodiments, the thermal camera may utilize a fixed focus (i.e., point and shoot), an autofocus (i.e., automatically focuses on the vehicle), laser-assisted focus (i.e., using a laser to determine the distance to the vehicle and adjusting focus proportional), multifocal mechanism (i.e., captures and blends multiple images of the vehicle into one comprehensive image), or any other appropriate focusing mechanism.

At 1420, the method 1400 may include generating the prediction based on the identifiable features of the vehicle. The operations of 1420 may be performed in accordance with the examples as disclosed herein. In some examples, aspects of the operations of 1420 may be performed by the heat signature component 750 as described with reference to FIG. 7. In some embodiments, the vehicle prediction component 730 may recognize data objects associated with the heat signature of the vehicle utilizing at least one of a single-shot multi-box detector (SSD), RetinaNet, you only look once (YOLO), region-based convolution neural network (R-CNN), Fast R-CNN, Mask R-CNN, or any combination thereof.

In some embodiments, the thermal imaging of the vehicle may allow the processor 830 to identify heat signature specific features of the vehicle. In some embodiments, heat signature-specific features may comprise engine heat, engine size, engine position, spoiler size, spoiler heat, spoiler position, number of spoilers, battery heat, battery position, number of batteries, and any other heat-related identifier. In some embodiments, the lack of a heat signature in the front or back of the vehicle may indicate the vehicle utilizes electric motors.

At 1425, the method 1400 may include determining whether the prediction of the at least one data object matches a vehicle profile from a vehicle profile data store. The operations of 1425 may be performed in accordance with examples as disclosed herein. In some examples, aspects of the operations of 1425 may be performed by the vehicle matching component 735 as described with reference to FIG. 7. In some embodiments, the vehicle profile data store may be stored in profile data store 165, the memory 825, and/or the database 835. In some embodiments, the vehicle profile data may be stored as a structured document (e.g., HTML, XML, EXCEL, structured query language (SQL), and any other appropriate structured document format).

In some embodiments, the processor 830 may utilize an equality-based approach wherein the data records may be matched when some or all the attributes of the vehicle match the vehicle profile. For example, the vehicle profile data may contain the heat signature, make, model, color, and license plate of a vehicle, and the processor 830 may have determined that the make, model, and license plate of the vehicle match the entry, but the heat signature is not a match. The processor 830 may determine that the heat signature is not similar enough for a match since the heat signature of a car should be fairly consistent; thus, the vehicle is not a predicted match for the vehicle profile since the heat signature may be weighted more heavily than the remaining attributes which do match.

In some embodiments, the processor 830 may use a pairwise comparison to determine when the vehicle matches a vehicle profile. In some embodiments, the processor 830 may utilize deterministic record linkages where weights are assigned to each field and similarity scores are calculated based on a set of defined rules to determine when a vehicle is a match to a vehicle profile. For example, the license plate field may be given a high weight so a match of a license plate string between the vehicle and a vehicle profile is more likely to be a match.

At 1430, the method 1400 may include communicating a result of determining whether the prediction of the of the at least one data object matches the vehicle profile. The operations of 1430 may be performed in accordance with examples as disclosed herein. In some examples, aspects of the operations of 1430 may be performed by the result communication interface 740 as described with reference to FIG. 7. In some embodiments, the result communication interface 740 may output the result via a display, an auditory output, haptic feedback, a notification to a client computing device, or some combination thereof.

A method for data processing by an apparatus is described. The method may include receiving, at a server and from a computing device associated with at least one camera, at least one image of a vehicle detected in a vehicle detection zone during a first time period, generating, using the at least one image, a prediction of at least one data object associated with the vehicle, determining whether the prediction of the at least one data object matches a vehicle profile from a vehicle profile data store, and communicating a result of determining whether the prediction of the at least one data object matches the vehicle profile.

An apparatus for data processing is described. The apparatus may include one or more memories storing processor executable code, and one or more processors coupled with the one or more memories. The one or more processors may individually or collectively be operable to execute the code to cause the apparatus to receive, at a server and from a computing device associated with at least one camera, at least one image of a vehicle detected in a vehicle detection zone during a first time period, generate, using the at least one image, a prediction of at least one data object associated with the vehicle, determine whether the prediction of the at least one data object matches a vehicle profile from a vehicle profile data store, and communicate a result of determining whether the prediction of the at least one data object matches the vehicle profile.

Another apparatus for data processing is described. The apparatus may include means for receiving, at a server and from a computing device associated with at least one camera, at least one image of a vehicle detected in a vehicle detection zone during a first time period, means for generating, using the at least one image, a prediction of at least one data object associated with the vehicle, means for determining whether the prediction of the at least one data object matches a vehicle profile from a vehicle profile data store, and means for communicating a result of determining whether the prediction of the at least one data object matches the vehicle profile.

A non-transitory computer-readable medium storing code for data processing is described. The code may include instructions executable by one or more processors to receive, at a server and from a computing device associated with at least one camera, at least one image of a vehicle detected in a vehicle detection zone during a first time period, generate, using the at least one image, a prediction of at least one data object associated with the vehicle, determine whether the prediction of the at least one data object matches a vehicle profile from a vehicle profile data store, and communicate a result of determining whether the prediction of the at least one data object matches the vehicle profile.

Some examples of the method, apparatus, and non-transitory computer-readable medium described herein may further include operations, features, means, or instructions for creating, based on determining that the prediction of the at least one data object fails to match the vehicle profile, a new vehicle profile for the vehicle including at least one descriptor corresponding to the at least one data object and assigning a vehicle token to the vehicle profile, where communicating the result includes storing the vehicle profile in a data store.

In some examples of the method, apparatus, and non-transitory computer-readable medium described herein, generating the prediction of the at least one data object may include operations, features, means, or instructions for transmitting, to one or more vehicle identification services, the at least one image of the vehicle and receiving, from the one or more vehicle identification services, a prediction of a license plate string identified from the at least one image, where the prediction includes the license plate string and a confidence score associated with the prediction of the license plate string.

In some examples of the method, apparatus, and non-transitory computer-readable medium described herein, determining whether the prediction of the at least one data object matches the vehicle profile may include operations, features, means, or instructions for determining, based on the confidence score may be greater than a threshold, whether the license plate string matches a license plate string in a set of multiple vehicle profiles in the vehicle profile data store.

In some examples of the method, apparatus, and non-transitory computer-readable medium described herein, determining whether the prediction of the at least one data object matches the vehicle profile may include operations, features, means, or instructions for determining, that the confidence score may be less than a threshold, identifying a subset of vehicle profiles of a set of multiple vehicle profiles in the vehicle profile data store that may have a license plate string length that matches a license plate string length of the predicted license plate string, and determining whether a threshold quantity of characters may be matched between the predicted license plate string and respective license plate strings of the subset of vehicle profiles.

Some examples of the method, apparatus, and non-transitory computer-readable medium described herein may further include operations, features, means, or instructions for determining, based on a threshold quantity of characters being matched, whether at least one additional data object prediction from the at least one image of the vehicle and including a make, model, or color, matches corresponding data objects of the subset of vehicle profiles, where the at least one additional data object may be received from the one or more vehicle identification services.

In some examples of the method, apparatus, and non-transitory computer-readable medium described herein, the threshold quantity may be based on the license plate string length.

In some examples of the method, apparatus, and non-transitory computer-readable medium described herein, the one or more vehicle identification services may be configured to return a prediction of a make of the vehicle, a model of the vehicle, or both, using a vehicle identification procedure that may include operations, features, means, or instructions for identifying a feature of the vehicle, drawing reference points on each feature, measuring respective distances between pairs of reference points, generating a point distance ratio from the measured respective distances, and generating the prediction of the make, the model, or both, based on the point distance ratio.

In some examples of the method, apparatus, and non-transitory computer-readable medium described herein, communicating the result of may include operations, features, means, or instructions for transmitting, to the computing device, an identifier for the matched vehicle profile or an identifier for a generated new vehicle profile.

In some examples of the method, apparatus, and non-transitory computer-readable medium described herein, generating the prediction may include operations, features, means, or instructions for detecting, based at least at in part on one or more heat signatures included in the at least one image that includes a thermal image captured by the at least one camera that includes a thermal camera, identifiable features of the vehicle and generating the prediction based on the identifiable features of the vehicle.

In some examples of the method, apparatus, and non-transitory computer-readable medium described herein, the identifiable features includes hood structure of a hood of the vehicle.

In some examples of the method, apparatus, and non-transitory computer-readable medium described herein, communicating the result may include operations, features, means, or instructions for communicating, to the computing device, an identifier for the vehicle, where the computing device may be configured to perform one or more actions based on the identifier.

The following provides an overview of aspects of the present disclosure:

Aspect 1: A method for data processing, comprising: receiving, at a server and from a computing device associated with at least one camera, at least one image of a vehicle detected in a vehicle detection zone during a first time period; generating, using the at least one image, a prediction of at least one data object associated with the vehicle; determining whether the prediction of the at least one data object matches a vehicle profile from a vehicle profile data store; and communicating a result of determining whether the prediction of the at least one data object matches the vehicle profile.

Aspect 2: The method of aspect 1, further comprising: creating, based at least in part on determining that the prediction of the at least one data object fails to match the vehicle profile, a new vehicle profile for the vehicle comprising at least one descriptor corresponding to the at least one data object; and assigning a vehicle token to the vehicle profile, wherein communicating the result comprises storing the vehicle profile in a data store.

Aspect 3: The method of any of aspects 1 through 2, wherein generating the prediction of the at least one data object comprises: transmitting, to one or more vehicle identification services, the at least one image of the vehicle; and receiving, from the one or more vehicle identification services, a prediction of a license plate string identified from the at least one image, wherein the prediction comprises the license plate string and a confidence score associated with the prediction of the license plate string.

Aspect 4: The method of aspect 3, wherein determining whether the prediction of the at least one data object matches the vehicle profile comprises: determining, based at least in part on the confidence score is greater than a threshold, whether the license plate string matches a license plate string in a plurality of vehicle profiles in the vehicle profile data store.

Aspect 5: The method of any of aspects 3 through 4, wherein determining whether the prediction of the at least one data object matches the vehicle profile comprises: determining, that the confidence score is less than a threshold; identifying a subset of vehicle profiles of a plurality of vehicle profiles in the vehicle profile data store that have a license plate string length that matches a license plate string length of the predicted license plate string; and determining whether a threshold quantity of characters are matched between the predicted license plate string and respective license plate strings of the subset of vehicle profiles.

Aspect 6: The method of aspect 5, further comprising: determining, based at least in part on a threshold quantity of characters being matched, whether at least one additional data object prediction from the at least one image of the vehicle and comprising a make, model, or color, matches corresponding data objects of the subset of vehicle profiles, wherein the at least one additional data object is received from the one or more vehicle identification services.

Aspect 7: The method of any of aspects 5 through 6, wherein the threshold quantity is based on the license plate string length.

Aspect 8: The method of any of aspects 5 through 7, wherein the one or more vehicle identification services are configured to return a prediction of a make of the vehicle, a model of the vehicle, or both, using a vehicle identification procedure that comprises: identifying a feature of the vehicle; drawing reference points on each feature; measuring respective distances between pairs of reference points; generating a point distance ratio from the measured respective distances; and generating the prediction of the make, the model, or both, based at least in part on the point distance ratio.

Aspect 9: The method of any of aspects 1 through 8, wherein communicating the result of comprises: transmitting, to the computing device, an identifier for the matched vehicle profile or an identifier for a generated new vehicle profile.

Aspect 10: The method of any of aspects 1 through 9, wherein generating the prediction comprises: detecting, based at least at in part on one or more heat signatures included in the at least one image that comprises a thermal image captured by the at least one camera that comprises a thermal camera, identifiable features of the vehicle; and generating the prediction based at least in part on the identifiable features of the vehicle.

Aspect 11: The method of aspect 10, wherein the identifiable features comprises hood structure of a hood of the vehicle.

Aspect 12: The method of any of aspects 1 through 11, wherein communicating the result comprises: communicating, to the computing device, an identifier for the vehicle, wherein the computing device is configured to perform one or more actions based at least in part on the identifier.

Aspect 13: An apparatus for data processing, comprising one or more memories storing processor-executable code, and one or more processors coupled with the one or more memories and individually or collectively operable to execute the code to cause the apparatus to perform a method of any of aspects 1 through 12.

Aspect 14: An apparatus for data processing, comprising at least one means for performing a method of any of aspects 1 through 12.

Aspect 15: A non-transitory computer-readable medium storing code for data processing, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

It should also be appreciated that the disclosed systems and methods have many applications including but not limited to parking structures, residential home garages, events such as concerts or sporting events, and car washes. The applications includes any application where vehicle identification, including identifying a vehicle based on characteristics of the vehicle are of interest.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, at a server and from a computing device associated with a camera, at least one image of a vehicle detected in a vehicle detection zone during a first time period;
generating, using the at least one image, a prediction of at least one data object associated with the vehicle;
determining whether the prediction of the at least one data object matches a vehicle profile from a vehicle profile data store; and
communicating a result of determining whether the prediction of the at least one data object matches the vehicle profile.

2. The method of claim 1, further comprising:
creating, based at least in part on determining that the prediction of the at least one data object fails to match the vehicle profile, a new vehicle profile for the vehicle comprising at least one descriptor corresponding to the at least one data object; and
assigning a vehicle token to the vehicle profile, wherein communicating the result comprises storing the vehicle profile in a data store.

3. The method of claim 1, wherein generating the prediction of the at least one data object comprises:
transmitting, to one or more vehicle identification services, the at least one image of the vehicle; and
generating, by the one or more vehicle identification services, a predicted license plate string identified from the at least one image, wherein the prediction comprises the predicted license plate string and a confidence score associated with the prediction of the predicted license plate string.

4. The method of claim 3, wherein determining whether the prediction of the at least one data object matches the vehicle profile comprises:
determining, based at least in part on the confidence score being greater than a threshold, whether the predicted license plate string matches a license plate string in a plurality of vehicle profiles in the vehicle profile data store.

5. The method of claim 3, wherein determining whether the prediction of the at least one data object matches the vehicle profile comprises:
determining, that the confidence score is less than a threshold;
identifying a subset of vehicle profiles of a plurality of vehicle profiles in the vehicle profile data store that have a license plate string length that matches a license plate string length of the predicted license plate string; and
determining whether a threshold quantity of characters are matched between the predicted license plate string and respective license plate strings of the subset of vehicle profiles.

6. The method of claim 5, further comprising:
determining, based at least in part on a threshold quantity of characters being matched, whether at least one additional data object prediction from the at least one image of the vehicle and comprising a make, model, or color, matches corresponding data objects of the subset of vehicle profiles, wherein the at least one additional data object is received from the one or more vehicle identification services.

7. The method of claim 5, wherein the threshold quantity is based on the license plate string length.

8. The method of claim 5, wherein the one or more vehicle identification services are configured to return a prediction of at least one of a make of the vehicle and a model of the vehicle, using a vehicle identification procedure that comprises:
identifying a feature of the vehicle;
drawing reference points on each feature;
measuring a respective distance between each pair of reference points;
generating a point distance ratio from the respective distances between each pair of reference points; and
generating the prediction of at least one of the make of the vehicle and the model of the vehicle, based at least in part on the point distance ratio.

9. The method of claim 1, wherein communicating the result of comprises:
transmitting, to the computing device, at least one of an identifier for the matched vehicle profile and an identifier for a generated new vehicle profile.

10. The method of claim 1, wherein generating the prediction comprises:
detecting, based at least at in part on one or more heat signatures included in the at least one image that comprises a thermal image captured by the camera that comprises a thermal camera, identifiable features of the vehicle; and
generating the prediction based at least in part on the identifiable features of the vehicle.

11. The method of claim 10, wherein the identifiable features comprises hood structure of a hood of the vehicle.

12. The method of claim 1, wherein communicating the result comprises:
communicating, to the computing device, an identifier for the vehicle, wherein the computing device is configured to perform one or more actions based at least in part on the identifier.

13. An apparatus for data processing, comprising:
one or more memories storing processor-executable code; and
one or more processors coupled with the one or more memories and individually or collectively operable to execute the code to cause the apparatus to:
receive, at a server and from a computing device associated with at least one camera, at least one image of a vehicle detected in a vehicle detection zone during a first time period;
generate, using the at least one image, a prediction of at least one data object associated with the vehicle;
determine whether the prediction of the at least one data object matches a vehicle profile from a vehicle profile data store; and
communicate a result of determining whether the prediction of the at least one data object matches the vehicle profile.

14. The apparatus of claim 13, wherein the one or more processors are individually or collectively further operable to execute the code to cause the apparatus to:
create, based at least in part on determining that the prediction of the at least one data object fails to match the vehicle profile, a new vehicle profile for the vehicle comprising at least one descriptor corresponding to the at least one data object; and
assign a vehicle token to the vehicle profile, wherein communicating the result comprises storing the vehicle profile in a data store.

15. The apparatus of claim 13, wherein, to generate the prediction of the at least one data object, the one or more processors are individually or collectively operable to execute the code to cause the apparatus to:
transmit, to one or more vehicle identification services, the at least one image of the vehicle; and
generating, by the one or more vehicle identification services, a predicted license plate string identified from the at least one image, wherein the prediction comprises the predicted license plate string and a confidence score associated with the prediction of the predicted license plate string.

16. The apparatus of claim 15, wherein, to determine whether the prediction of the at least one data object matches the vehicle profile, the one or more processors are individually or collectively operable to execute the code to cause the apparatus to:
determine, based at least in part on the confidence score being greater than a threshold, whether the predicted license plate string matches a license plate string in a plurality of vehicle profiles in the vehicle profile data store.

17. The apparatus of claim 15, wherein, to determine whether the prediction of the at least one data object matches the vehicle profile, the one or more processors are individually or collectively operable to execute the code to cause the apparatus to:
determine, that the confidence score is less than a threshold;
identify a subset of vehicle profiles of a plurality of vehicle profiles in the vehicle profile data store that have a license plate string length that matches a license plate string length of the predicted license plate string; and
determine whether a threshold quantity of characters are matched between the predicted license plate string and respective license plate strings of the subset of vehicle profiles.

18. A non-transitory computer-readable medium storing code for data processing, the code comprising instructions executable by one or more processors to:
receive, at a server and from a computing device associated with at least one camera, at least one image of a vehicle detected in a vehicle detection zone during a first time period;
generate, using the at least one image, a prediction of at least one data object associated with the vehicle;
determine whether the prediction of the at least one data object matches a vehicle profile from a vehicle profile data store; and
communicate a result of determining whether the prediction of the at least one data object matches the vehicle profile.

19. The non-transitory computer-readable medium of claim 18, wherein the code is further executable by the one or more processors to:
create, based at least in part on determining that the prediction of the at least one data object fails to match the vehicle profile, a new vehicle profile for the vehicle comprising at least one descriptor corresponding to the at least one data object; and
assign a vehicle token to the vehicle profile, wherein communicating the result comprises storing the vehicle profile in a data store.

20. The non-transitory computer-readable medium of claim 18, wherein the code to generate the prediction of the at least one data object are executable by the one or more processors to:
transmit, to one or more vehicle identification services, the at least one image of the vehicle; and
receive, from the one or more vehicle identification services, a prediction of a license plate string identified from the at least one image, wherein the prediction comprises the license plate string and a confidence score associated with the prediction of the license plate string.
